(19) United States
(12) Patent Application Publication
(10) Pub. No.: US 2015/0238029 A1
(43) Pub. Date: Aug. 27, 2015

(54) NUTRITIVE DELIVERY SYSTEM

(71) Applicant: Donald Bruce Chelemedos, Half Moon Bay, CA (US)

(72) Inventor: Donald Bruce Chelemedos, Half Moon Bay, CA (US)

(21) Appl. No.: 14/191,840

(22) Filed: Feb. 27, 2014

(51) Int. Cl. A47G 19/18; A23L 1/30; A45F 3/16; B65B 1/00; A47G 19/12; A47G 23/00; A23L 2/52; A23L 1/302

(52) U.S. Cl. CPC A47G 19/183; A23L 2/52; A23L 1/30; A23L 1/3002; A23L 1/302; B65B 1/00; A47G 19/12; A47G 23/00; A45F 3/16

(57) ABSTRACT

A system for dispensing a nutritive source is described. The system includes: a culinary mix including a blended food; a collapsible pouch configured for holding the culinary mix; and a push-pull cap configured for being coupled with the collapsible pouch, and when the collapsible pouch is squeezed, configured for receiving the culinary mix from the collapsible pouch and for dispensing received culinary mix.

### BACKGROUND

Traditionally, packaged energy bars and energy/sport drinks are designed to provide nutrients to an athlete in the time period surrounding an athletic performance.

At the same time, however, the logistics of eating energy bars during an athletic performance can create several problems for the athlete. First, it is difficult for an athlete to remain focused and sustain a consistent performance level while trying to unwrap and consume an energy bar, followed by the proper disposal of the wrapper. This effort can be distracting to the athlete and reduce his/her performance level. Second, the wrapper may not have resealing attributes that can make storing a remaining portion of the energy bar for subsequent consumption problematic. Further, an energy bar may provide only some of the key vitamins and nutrients desired by an athlete, while delivering unneeded and/or unwanted calories in trying to satisfy the desired nutrient intake level. Moreover, many energy snacks that are designed for athletes require the use of both hands for consumption. This can present a problem for athletes participating in activities that require the use of at least one hand much of the time, such as cycling, race car driving, etc.

Consuming energy/sport drinks while performing an athletic event can also cause problems for the athlete. For example, awkwardly carrying an empty container or water bottle during an athletic performance is inconvenient and difficult. Moreover, during and after a long race or a particularly strenuous activity, an athlete may prefer to eat a meal in addition to or rather than drink a liquid to replace lost and vital nutrients.

Thus, the traditional methods by which athletes fortify themselves before, during, and after a sporting event has presented many problems and undesirable outcomes.

### SUMMARY

One aspect of a system for dispensing a nutritive source is disclosed. The system includes a culinary mix that includes a blended food, a collapsible pouch configured for holding the blended food, and a push-pull cap configured for being coupled with the collapsible pouch. When the collapsible pouch is squeezed, the push-pull cap is configured for receiving the culinary mix from the collapsible pouch and for dispensing the received culinary mix.

An aspect of a device for dispensing a nutritive source is disclosed. The device includes a push-pull cap that is configured for being attached onto a portion of a straw disposed at least partially within a collapsible pouch. The push-pull cap includes: an inner piece; and an outer piece. The inner piece is configured for receiving a culinary mix from the collapsible pouch when the collapsible pouch is squeezed. The inner piece includes: an inner surface; and an outer surface. The inner surface includes an inner piece attachment mechanism disposed thereon and configured for coupling with said collapsible pouch upon application of the inner piece attachment mechanism to a straw attachment mechanism disposed on the portion of the straw. The outer piece is axially slidably engaged with the outer diameter of the inner piece. The outer piece is configured for, upon sliding over the outer surface of the inner piece, enabling the push-pull cap to achieve one of an open position and a closed position. When the collapsible pouch is squeezed and the push-pull cap is in the open position, the open position enables a dispensation of the culinary mix (that was received from the collapsible pouch) through a dispensation passageway disposed at an upper end of the outer piece.

An aspect of a method for manufacturing a system for dispensing a nutritive source is disclosed. The method for manufacturing includes: providing a culinary mix that includes a blended food; providing a collapsible pouch configured for holding the culinary mix; and providing a push-pull cap configured for being attached onto a portion of a straw disposed at least partially within the collapsible pouch. The push-pull cap includes: an inner piece; and an outer piece. The inner piece is configured for receiving a culinary mix from the collapsible pouch when the collapsible pouch is squeezed. The inner piece includes: an inner surface; and an outer surface. The inner surface includes an inner piece attachment mechanism disposed thereon and configured for coupling with said collapsible pouch upon application of the inner piece attachment mechanism to a straw attachment mechanism disposed on the portion of the straw. The outer piece is axially slidably engaged with the outer diameter of the inner piece. The outer piece is configured for, upon sliding over the outer surface of the inner piece, enabling the push-pull cap to achieve one of an open position and a closed position. When the collapsible pouch is squeezed and the push-pull cap is in the open position, the open position enables a dispensation of the culinary mix (that was received from the collapsible pouch) through a dispensation passageway disposed at an upper end of the outer piece.

It is understood that other embodiments will become readily apparent to those skilled in the art from the following detailed description, wherein various embodiments are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Aspects of the present invention are illustrated by way of example, and not by way of limitation, in the accompanying drawings, wherein:

FIG. 1 is a side perspective view showing a system for dispensing a nutritive source, in accordance with embodiments.

FIG. 2A is a side perspective view showing a collapsible pouch with a traditional cap screwed thereon.

FIG. 2B is a side perspective view showing a collapsible pouch with a push-pull cap screwed onto the neck of the collapsible pouch, in accordance with embodiments.

FIG. 2C is a side perspective view showing a push-pull cap breakably sealed onto a neck of the collapsible pouch, in accordance with embodiments.

FIG. 3A is a side perspective view showing a collapsible pouch with an attached neck, and a sectional view of a straw coupled to the neck, in accordance with embodiments.

FIG. 3B is a side sectional view showing a collapsible pouch with an attached neck, and a sectional view of a push-pull cap placed over the neck, the push-pull cap being in a closed position, in accordance with embodiments.

FIG. 3C is a side sectional view showing a push-pull cap and a collapsible pouch with a straw, in accordance with embodiments.

FIG. 3D is a side sectional view showing a collapsible pouch with a straw, including a neck of the straw, in accordance with an embodiment.

FIG. 4 is a side sectional view showing a collapsible pouch with an attached neck, and a sectional view of a push-pull cap placed over the neck, the push-pull cap being in an open position, in accordance with embodiments.

FIG. 5A is a side sectional view showing an inner piece of a push-pull cap, in accordance with embodiments.

FIG. 5B is a top perspective view showing an inner piece of a push-pull cap, in accordance with embodiments.

FIG. 6 is a side perspective view showing a collapsible pouch and a pouring means for delivering a culinary mix into the collapsible pouch via the neck coupled to the collapsible pouch, in accordance with embodiments.

FIG. 7 is a side perspective view showing a culinary mix dispenser, in accordance with embodiments.

FIG. 8 is a flow chart of an example method 800 for manufacturing a system for dispensing a nutritive source, in accordance with embodiments.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments.

Traditionally, athletes eat packaged energy bars, sport goos, and energy/sport drinks containing vitamins, carbohydrates, electrolytes, etc. to replace nutrients lost during an athletic performance and/or to increase their energy and stamina during the performance. However, current energy food and drinks do not always provide the athlete with every nutrient that is needed to enable the athlete's optimal performance or to satisfy the athlete's emotional needs. Packaged energy snacks may not always satisfy an athlete's hunger or provide the desired energy boost or nutrients required. Further, consuming traditional energy food and drinks during a sporting event is difficult due to the packaging delivery system associated with traditional energy/sport foods. For example, an energy bar requires an athlete to tear open a package in order to access the food within. The athlete may try to tear the package open with his hands or teeth, and may not accomplish this task in a manner that makes eating the food easy during the athletic performance. Thus, while already an unwelcome distraction for the athlete, he/she may also not even be able to ingest the food quickly, if at all, due to the manner in which the athlete is required to open the package. For example, eating energy bars during a performance requires peeling a wrapper and discarding the resultant trash, which could create a distraction and reduce the athlete's level of performance. Thus, the athlete would be less likely to consume energy drinks/sport drinks in lieu of eating a quick and convenient meal fortified with the desired nutrients.

Various embodiments provide a collapsible pouch with a push-pull cap that may be easily opened with only one hand and/or teeth by an athlete prior to, during or following a performance. The collapsible pouch can systematically contain a combination of selected and/or customized pureed foods (e.g., organic fruits, vegetables, mashed potatoes) and selected and/or customized enhancements (e.g., vitamins; energy boosts; electrolytes; caffeine), in some embodiments. An athlete, such as a cyclist on a 6-8 hour ride or a marathon runner having reached mile fifteen, is able to easily open the push-pull cap (as well as easily close) and eat the pureed food without inhibiting or stopping his performance. In this way, an athlete may receive a heightened quality of nutritive meal replacements, while reducing and/or eliminating the disruption to his performance caused by eating and drinking traditional energy supplements packaged in the traditional manner. While reference to embodiments is described in terms of an athlete and his/her performance, it should be appreciated that anyone may benefit from the use of embodiments, since they provide a healthy meal alternative regardless of the user's status (e.g., athlete or non-athlete).

Below, embodiments for dispensing a nutritive source are discussed, including the following: 1) a system for dispensing a nutritive source; 2) a device for dispensing a nutritive source, including a push-pull cap; and 3) a system for dispensing a nutritive source, including a culinary mix dispenser; and 4) a method of manufacturing a system for dispensing a nutritive source.

### 1) Example System for Dispensing a Nutritive Source

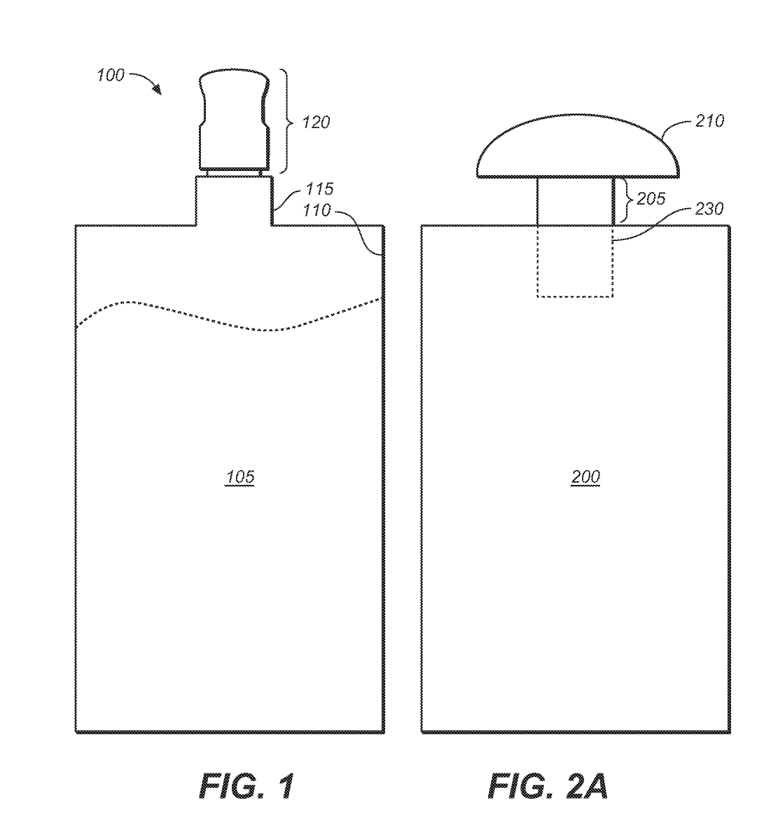

FIG. 1 is a side perspective view showing a system 100 for dispensing a nutritive source. The system 100 includes a culinary mix 105 (shown within the collapsible pouch 110), a collapsible pouch 110 configured for holding the culinary mix 105 and a push-pull cap 120 configured for being coupled with the collapsible pouch 110. The collapsible pouch 110 may collapse to become compressed to a smaller size. In some embodiments, the collapsible pouch 110 is of a kind of pouch known in the art and produced, in various forms, by, for example, Cheer Pack North America (headquartered in West Bridgewater, Mass.). The culinary mix 105 includes a blended food. The push-pull cap 120 is configured such that it may receive and dispense the culinary mix 105 upon the receipt of a squeeze to the collapsible pouch 110. The collapsible pouch 110, in various embodiments, is fillable during the manufacturing of the system 100, and in other embodiments, is fillable post-manufacturing of the system 100, thus enabling the customization of a nutritive source for dispensation.

In various embodiments, the culinary mix 105 includes any of the following: one or more grain; one or more fruit; one or more vegetable; one or more dairy product; one or more type of meat; and one or more dessert. The culinary mix 105, in various embodiments, combines food to create the flavor of a meal. For example, meals tasting like a Thanksgiving dinner may be created in various packages. One collapsible pouch may contain a culinary mix resembling and having the flavor of turkey and stuffing, while another collapsible pouch may contain a culinary mix resembling and having the flavor of yams and marshmallows. Each collapsible pouch may contain a different culinary mix that resembles and/or tastes like a particular type of meal, food group, or singular food item. The blended food of the culinary mix 105, in one embodiment, includes a thick liquid suspension of food that is finely ground, such as pureed food. In another embodiment, the blended food included the thick liquid suspension of food, along with at least one edible piece of food that is in a different stated from a larger state than the state of the thick liquid suspension of the food that is finely ground. In other words, in one embodiment, the blended food includes, not only pureed food that is finely ground, but at least one food bit that is larger than the general size of any of the pureed food particles. Thus, in one embodiment, the blended food may contain what is a thick liquid suspension of finely ground mash potatoes and gravy. However, in another embodiment, the blended food may contain not only what is a thick liquid suspension of finely ground mash potatoes and gravy, but also bits of peas or whole peas floating within the suspension. Each of the bits of peas is larger than any particle of the thick liquid suspension of the finely ground mash potatoes and gravy.

In further embodiments, the culinary mix 105 includes edible enhancements, such as, but not limited to: a set of vitamins; a set of minerals; a set of herbs; electrolytes (e.g., sodium, potassium, calcium, magnesium); caffeine; carbohydrates; guarana; taurine; medicine; food flavoring; food coloring; food preservatives; and alcohol. Referring to the aforementioned “set” of vitamins, mineral and herbs, a “set” refers to one or more of the object under consideration (e.g., a set of vitamins is equal to one or more vitamins). In various embodiments, enhancements are ground up into a texture that is easily digestible and/or drinkable by a human. It should be appreciated that enhancements may be any object that is edible.

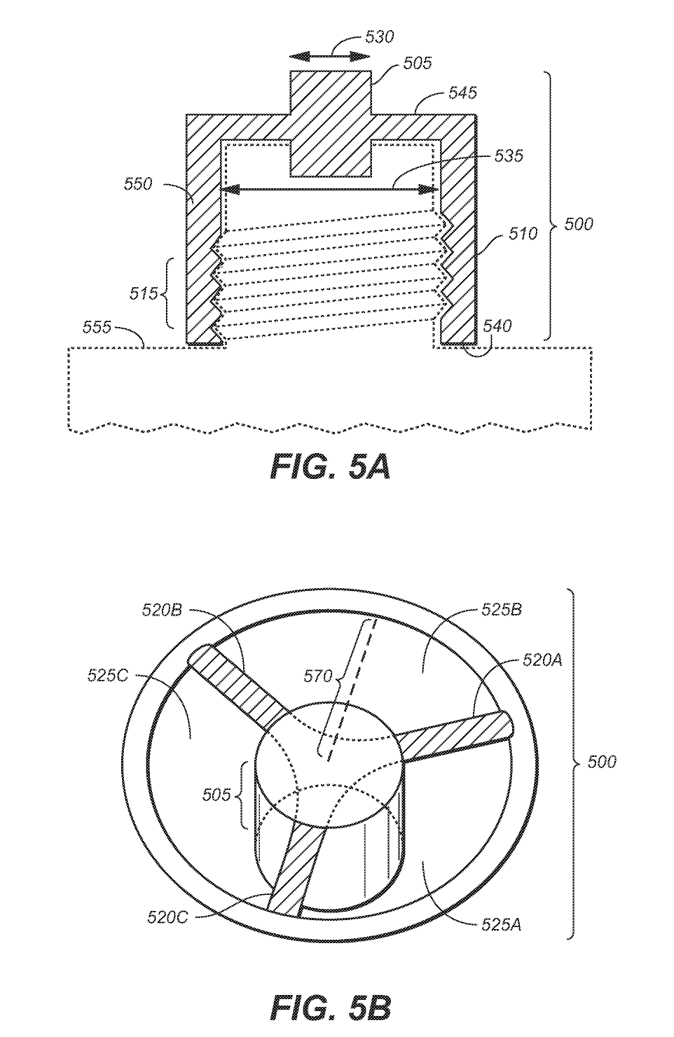

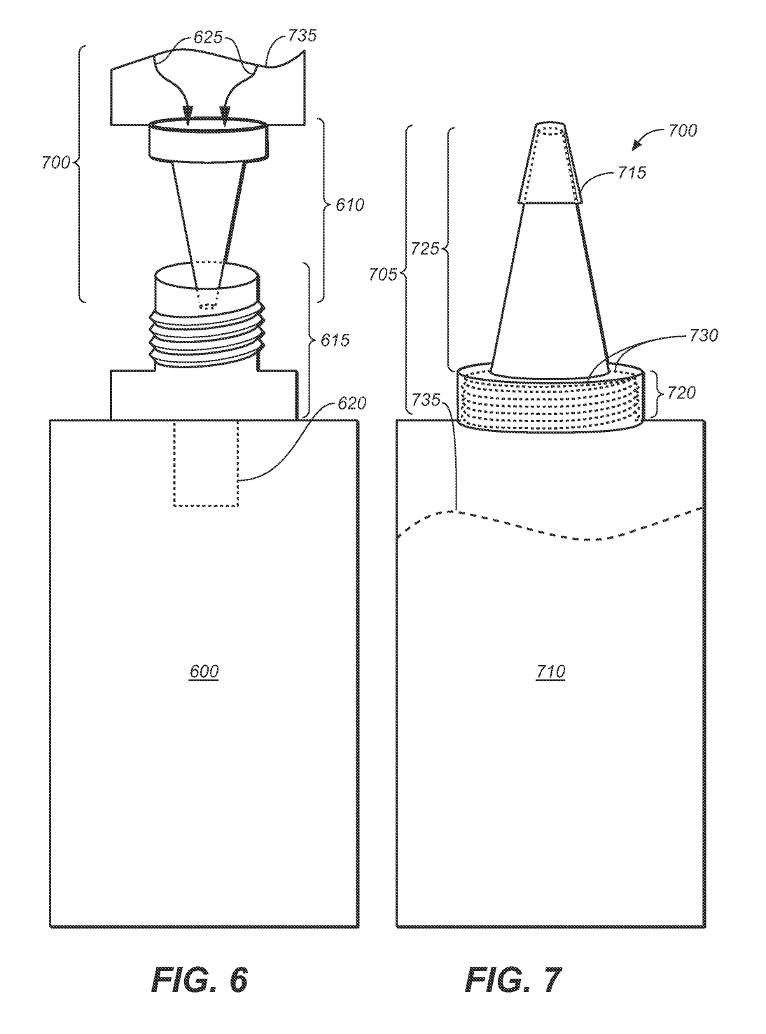

Further, in one embodiment, the system 100 includes the collapsible pouch 110 that is filled with the culinary mix 105 at the time of manufacture. However, another embodiment provides for a system, that further includes a culinary mix dispenser (see FIGS. 6 and 7 and related discussion below), in which the culinary mix dispenser is used fill the collapsible pouch 110 with the culinary mix (by a person, for example) after the manufacturing of the system 100.

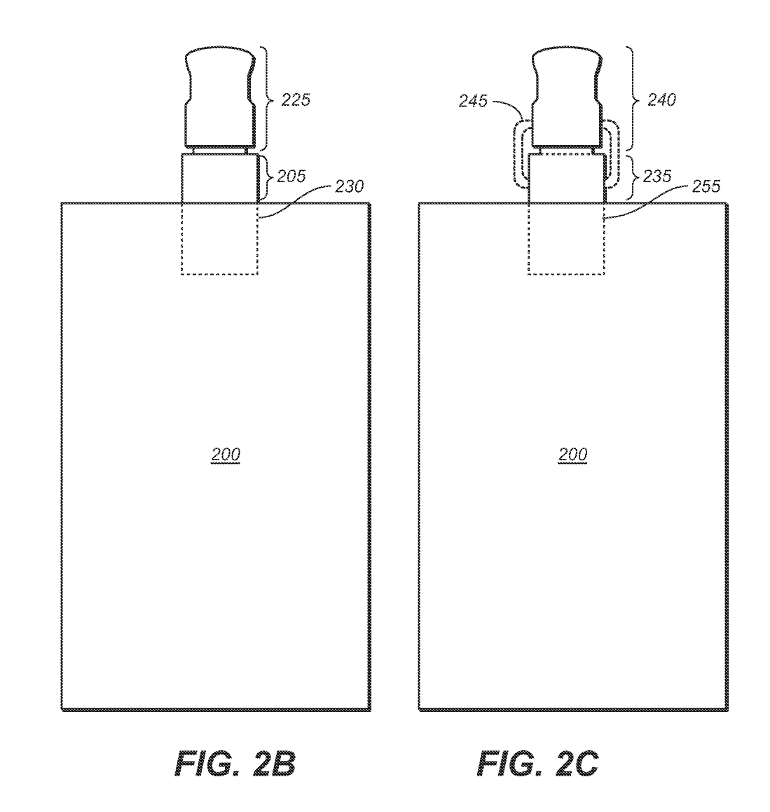

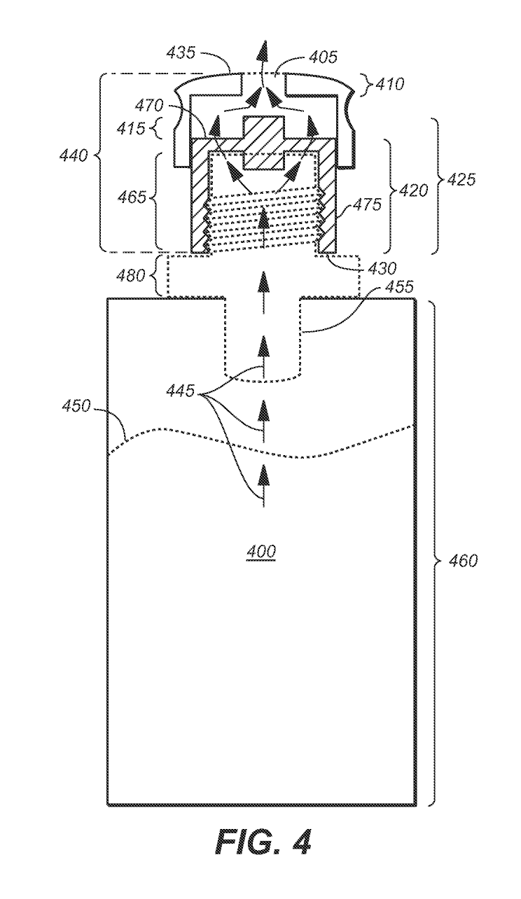

FIG. 2A is a side perspective view showing a collapsible pouch 200 (currently being used in the market place) with a traditional cap 210, such as that produced by Cheer Pack North America, screwed onto the neck 205 of the straw 230 of the collapsible pouch 200. Of note, the straw 230 is partially internal to the collapsible pouch 200 and includes the neck 205. FIG. 2B is a side perspective view showing the collapsible pouch 200 with a push-pull cap 225 screwed onto the neck 205 of the straw 230, in accordance with embodiments. The traditional cap 210 that fits onto the collapsible pouch 200 requires two hands to attach or remove. In this example, the traditional cap 210 requires two hands to screw and unscrew the cap 210 from the collapsible pouch 200. Further, problems ensue for athletes during their performance, or non-athletes, when they try to remove, hold or maintain the whereabouts of the traditional cap 210 while eating/drinking the food contained within the collapsible pouch onto which the traditional cap 210 was threaded. Embodiments provide for a push-pull converter cap 225 made to fit the dimensions of the neck 205 of the straw 230 of the collapsible pouch 200 such that the push-pull converter cap 225 may be threaded onto the neck 205. Thus, the push-pull cap 225 may be used with the traditional collapsible pouch 200, in accordance with some embodiments. The push-pull cap 225, as will be described herein, in some embodiments, includes filter passageways disposed between plunger braces (see FIGS. 5A and 5B and discussion below) that facilitate the more rapid dispensation of the culinary mix through the push-pull cap 225.

FIG. 2C is a side perspective view showing a push-pull cap 240 breakably sealed, via a seal 245, onto a straw 255 (e.g., the neck 235 of the straw 255) of a collapsible pouch 200, in accordance with embodiments. The seal 245 represents any means of sealing the push-pull cap 240 to the straw 255 that is known in the art. For example, the seal 245 may be made of breakable plastic such that when a user pulls the push-pull cap 240 open, the force being exerted breaks the seal 245. A seal 245 that is intact (i.e., unbroken) indicates that the collapsible pouch 200 has not been opened. However, a seal 245 that is broken indicates that the collapsible pouch 200 has possibly been opened or has been opened.

As will be explained herein, the push-pull cap is coupled with the collapsible pouch through a variety of means. In various embodiments, the push-pull cap may be screwed onto the collapsible pouch, snapped onto the collapsible pouch, or any combination thereof.

### Example Device for Dispensing a Nutritive Source

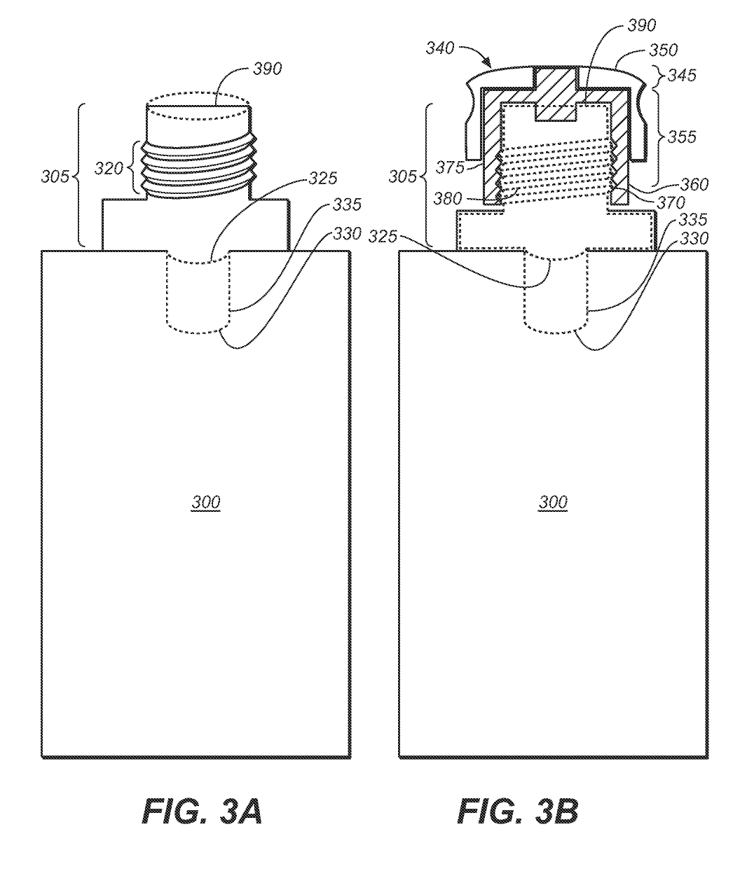

With reference to FIGS. 3A, 3B, 3C, 3D, 4, 5A and 5B, a device for dispensing a nutritive source will be described below, in accordance with embodiments. The device for dispensing a nutritive source, in accordance with embodiments, includes a push-pull cap. FIG. 3A introduces components of the collapsible pouch 300, onto which the push-pull cap is attached (e.g., threaded, snapped-on), according to embodiments. FIG. 3B introduces components of the push-pull cap 340 in cooperation with the straw 335 (including the neck 305 of the straw 335), of the collapsible pouch 300.

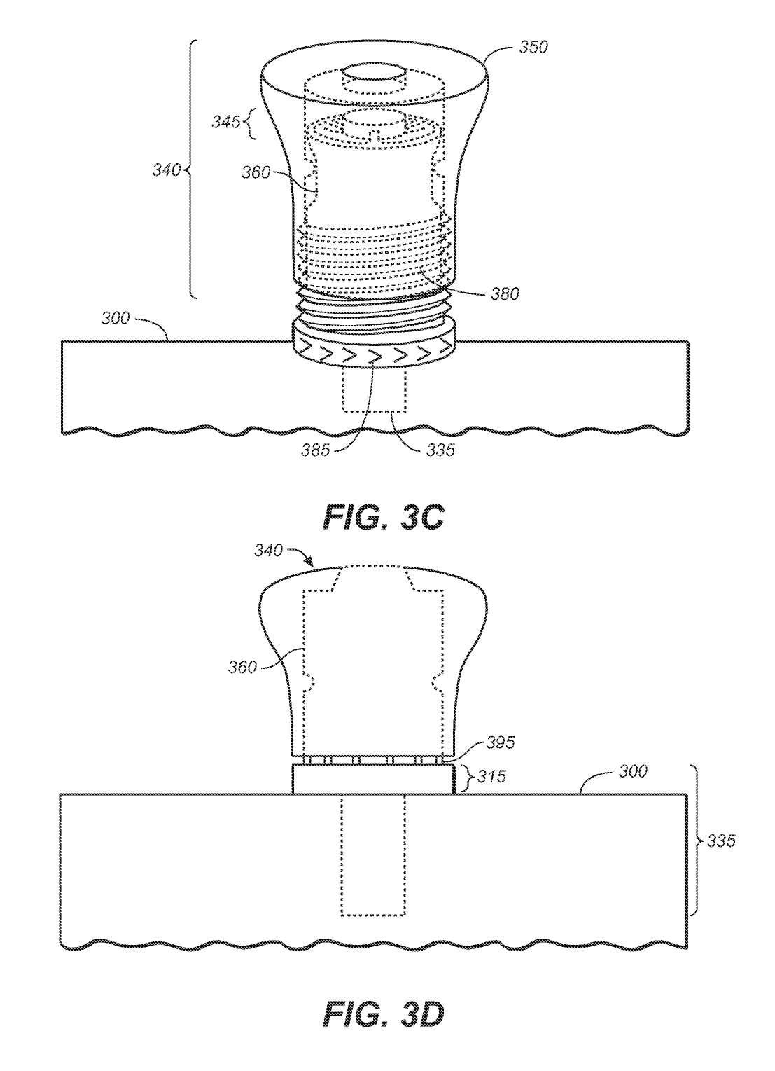

FIG. 3A is a side perspective view showing a collapsible pouch 300 with a straw 335, including a neck 305 of the straw 335, in accordance with embodiments. In one embodiment, the straw 335 has a first end opening 330 which opens to the internal portion of the collapsible pouch 300 and a second end opening 325 which opens to the neck 305 of the straw 335. In various embodiments, the straw 335 also has a third end opening 390. When the push-pull cap 340 is in the open position, the third end opening 390 opens to the inner piece 360, the dispensation passageway 405 (discussed below with reference to FIG. 4) and the environment external to the push-pull cap 340. In one embodiment, the push-pull cap 340 is attached to a portion of the straw 335 that is disposed at least partially within the collapsible pouch 300.

In one embodiment, the outer surface of the neck 305 of the straw 335 includes threads 320 disposed thereon.

In one embodiment, a straw (not shown in figures) is disposed entirely within the collapsible pouch 300, and the push-pull cap is configured to attach to this straw. Access to the internal passageway formed by the straw (that is positioned such that the straw is entirely disposed within the collapsible pouch 300) is where it is closest to the edge of the collapsible pouch 300. In various embodiments in which the straw is entirely disposed within the collapsible pouch 300, the straw does not have a second end opening 325; it has a first end opening 330 and the third end opening 390. In these embodiments, the third end opening 390 is that opening which is closest to the edge of the collapsible pouch 300 and provides access to the internal passageway formed by the straw. In one embodiment, the inner surface of the straw 335 includes threads disposed thereon.

FIG. 3B is a side sectional view showing a collapsible pouch 300 with a straw 335, including a neck 305 of the straw 335, wherein the push-pull cap 340 is in a closed position, in accordance with embodiments. The push-pull cap 340 is configured for being attaches onto a portion of the straw 335 that is disposed at least partially within the collapsible pouch 300. In other words, the push-pull cap 340 may be attached to the straw 335 and removed from the straw 335.

The push-pull cap 340 will be described with reference to FIGS. 3A-3C. While FIGS. 3A-3C show sets of threads 320 and 380 disposed on the straw 335 and the inner piece 360, respectively, it should be appreciated that the push-pull cap 340 and the straw 335, in various embodiments and as will discussed herein, do not have sets of threads thereon, but have instead other attachment mechanisms configured for attaching to each other.

With reference still to FIGS. 3A-3D, the push-pull cap 340 includes: an inner piece 360; and an outer piece 350. The inner piece 360 includes an inner piece attachment mechanism disposed thereon and an outer surface 375. The attachment mechanism of the inner piece 360 enables the inner piece 360 to attach to the straw 335 via attaching to a straw attachment mechanism disposed on the straw 335. As shown in FIGS. 3A-3D, in one embodiment, the inner piece attachment mechanism is a set of threads 380 and the straw attachment mechanism is also a set of threads 320. It should be appreciated that the straw attachment mechanism may include a set of teeth 315 (see FIG. 3C), as will be discussed below. Thus, it should be appreciated that the push-pull cap 340 may be attached to the straw 335 coupled to the collapsible pouch 300 in any way that enables fluid and food communication between the collapsible pouch 300 and the push-pull cap 340. Of note and as is indicated herein, it should be appreciated that the inner piece attachment mechanism and the straw attachment mechanism may be disposed on the inner or outer surfaces of the inner piece 360 and the straw 335 to accommodate various embodiments of such attachments.

In one embodiment, the push-pull cap 340 is configured for being removably screwed onto a portion of the straw 335. In other words, the push-pull cap 340 may be screwed onto the straw 335 and unscrewed and taken off of the straw 335, via the set of threads 380 disposed on the inner piece 360 and the set of threads 320 disposed on the straw 335. For example, in one embodiment, the set of threads 380 are disposed on the inner surface 370 of the inner piece 360, and the set of threads 320 are disposed on the outer surface of the neck 305 of the straw 335. The sets of threads 380 and 320 engage with each other, enabling the inner piece 360 and the straw 335 to become attached to each other.

The inner piece 360 is configured for receiving a culinary mix (including blended food) from the collapsible pouch 300 when the collapsible pouch 300 is squeezed, by, for example, a user of the collapsible pouch 300. The inner piece 360 includes: an inner surface 370; and an outer surface 375.

FIG. 3C is a side sectional view showing a push-pull cap 340 and a collapsible pouch 300 with a straw 335, in accordance with an embodiment. In FIG. 3C, the inner piece 360 includes a set of threads 380 and teeth 385. The inner piece 360 is enabled to couple with the collapsible pouch 300 upon the application of the set of threads 380 and the teeth 385 that are disposed on the inner surface of the inner piece 360 to the set of threads disposed on the outer surface (not shown) of the straw 335. Though not shown in FIG. 3C, in this embodiment, the straw 335 extends above and beyond the edge of the collapsible pouch 300. Thus, the inner piece attachment mechanism (e.g., combination of a set of threads 380 and the teeth 385) disposed on the inner surface of the inner piece 360 attaches to the straw attachment mechanism (e.g., set of threads [not shown]). It should be appreciated that the inner piece attachment mechanism may be a set of threads and/or teeth, while the straw attachment mechanism may also be a set of threads and/or teeth.

The teeth 385 are projections positioned on various portions of the inner piece and/or straw as described herein. In one embodiment, the set of threads 380 of the inner piece 360 and the teeth 385 are juxtaposed such that the teeth 385 and the set of threads 380 to slide over the straw 335 in one direction (e.g., while a user twists the push-pull cap 340 onto the straw 335), but the teeth 385 prevent the set of threads 380 from unscrewing in the opposite direction (e.g., while a user attempts to untwist the push-pull cap 340). For example, in one embodiment, the user is able to twist the push-pull cap 340 onto the straw 335; however, the teeth 385 are configured to prevent the untwisting of the push-pull cap 340 off of the straw 335. Thus, the push-pull cap 340, according to this embodiment, once twisted onto the straw 335, may not be twisted off. The teeth 385, in one embodiment, are slanted at less than a ninety degree angle in one direction, while being positioned in parallel and in line with the set of threads 380 of the inner piece 360 such that the teeth 385 and a portion of the set of threads 380 touch each other when the push-pull cap 340 is twisted onto the straw 335. It should be appreciated, however, that the teeth 385 may be configured in any arrangement (e.g., size, direction, positioning relative to each other) such that the push-pull cap 340 may be twisted and thereby become attached to the straw 335, while also being unable to be removed through a twisting motion in the opposite direction (from that motion which twisted the push-pull cap 340 onto the straw 335).

While not shown in FIG. 3C, another embodiment enables the push-pull cap 340 to couple with the collapsible pouch 300 upon the application of the set of threads and/or teeth (i.e., inner piece attachment mechanism) that are disposed on the outer surface of the inner piece 360 to the set of threads and/or teeth (i.e., straw attachment mechanism) that are disposed on the inner surface of the straw 335.

While also not shown in FIG. 3C, in yet another embodiment, the portion of the straw 335 that is internal to the collapsible pouch 300 may include a set of threads and/or teeth on its inner surface that is capable of cooperating with a set of threads and/or teeth disposed on the outer surface of the inner piece 360 in order to attach the inner piece 360 to the straw 335.

FIG. 3D is a side sectional view showing a collapsible pouch 300 with a straw 335, in accordance with an embodiment. In FIG. 3D, the inner piece 360 couples with the collapsible pouch 300 upon an application of a safety band 395 to the outer surface of the straw 335, such that the safety band 395 retains the inner piece 360 in an attached position to the straw 335. It should be appreciated that the safety band 395 may be any mechanism that retainably holds a portion of the push-pull cap 340 to the straw 335 attached to the collapsible pouch 300. The safety band 395, once applied to the outside of the straw 335, retains the push-pull cap 340 in its place adjacent to the neck 315 of the straw 335 such that the push-pull cap 340, upon an opening and closing motion, does not move such that it separates from the collapsible pouch 300.

Referring again to FIGS. 3A and 3B, the outer piece 350 is coupled to the inner piece 360. The outer piece 350 is axially slidably engaged with an outer diameter of the inner piece 360. The outer piece 350 is configured for, upon sliding over an outer surface 375 of the inner piece 360, enabling the push-pull cap 340 to achieve one of an open position and a closed position (i.e., either an open position or a closed position). When the collapsible pouch 300 is squeezed, by way of the push-pull cap 340 being in the open position, the push-pull cap 340 enables a dispensation of the culinary mix through a dispensation passageway (see FIG. 4) disposed at an upper end of the outer piece 350. It should be appreciated that the outer piece 350 may be engaged with the outer diameter of the inner piece 360 through various mechanisms, according to various embodiments. These mechanisms for opening and closing a push-pull cap include those mechanisms that are known in the art of push-pull caps.

FIG. 4 is a side sectional view showing a collapsible pouch with an attached neck, and a section view of a push-pull cap placed over the neck and in an open position, in accordance with embodiments. Of note, FIG. 4 shows the first end 430 and the second end 470 of the lower part 420 of the inner piece 425, as well as the annular sidewall 475 that couples the first end 430 and the second end 470 together. FIG. 4 also shows the lower neck 480 and upper neck 465 of the straw 455. FIG. 4 shows the flow 445 of the culinary mix 450 from the collapsible pouch 400 to the dispensation passageway 405, in accordance with embodiments. As shown, upon the collapsible pouch 400 being squeezed, the culinary mix 450 moves from the body 460 of the collapsible pouch 400, through the straw 455 and the lower neck 480 and the upper neck 465 of the straw 455. The culinary mix 450 then moves through the filter passageways 525A, 525B and 525C (hereinafter, “filter passageway 525” unless specifically noted otherwise) (see FIGS. 5A and 5B) to the dispensation passageway 405.

FIG. 3B shows the push-pull cap 340 in the closed position, while FIG. 4 shows the push-pull cap 440 in the open position. With reference to both FIGS. 3B and 4, when in the closed position, the dispensation passageway 405 has been moved, such that the upper part 345 (upper part 415 of FIG. 4) is positioned within the dispensation passageway 405 (not labeled in FIG. 3B), thereby blocking any flow of the received culinary mix from moving out of the push-pull cap 340. However, when the push-pull cap 440 is in the open position, the flow 445 of the culinary mix 450 can move through push-pull cap 440 and out the dispensation passageway 405.

FIG. 5A is a side sectional view showing an inner piece 500 of a push-pull cap, in accordance with embodiments. FIG. 5B is a top perspective view showing an inner piece 500 of a push-pull cap, in accordance with embodiments. With reference not to both FIGS. 5A and 5B, an inner piece 500 is shown that includes an annular lower part 510 and an annular upper part 505 coupled to the annular lower part 510. The annular lower part 510 includes: a first end 540; a second end 545 positioned opposite the first end 540; and an annular sidewall 550 coupling the first end 540 and the second end 545. The annular sidewall 550 includes the inner piece attachment mechanism (discussed above) (e.g., set of threads 515 disposed on the inner surface of the inner piece 500). In one embodiment, the annular lower part 510 includes a set of threads 515 disposed on the inner surface of the annular lower part 510. Further, The annular upper part 505 is coupled to the annular lower part 510 via at least two plunger braces 520A, 520B and 520C (hereinafter, “plunger brace 520” unless specifically noted otherwise) having filter passageways 525A, 525B and 525C (hereinafter, “filter passageway 525” unless specifically noted otherwise) disposed there between such that the received culinary mix is enabled to flow there through when the push-pull cap is in an open position. The annular upper part 505 is solid and does not allow any type of particles to flow there through. Further, the annular upper part 505 has a diameter 530 that is smaller than the diameter 535 of the annular lower part 510. The difference 570 between the diameter 530 of the annular upper part 505 and the diameter 535 of the annular lower part 510 represents the outer most width of the filter passageway 525. The smaller the diameter of the annular upper part 505, the greater the difference 570, the more food is able to flow through the filter passageways 525. Additionally, the smaller the number of plunger braces 520, the greater the area of the filter passageways 525, the more food is able to flow through the filter passageways 525.

In one embodiment and as described herein already, the culinary mix further includes at least one enhancement of the enhancements described herein.

### Example System for Dispensing a Nutritive Source, Including a Culinary Mix Package Dispenser

FIG. 6 is a side perspective view showing a collapsible pouch 600 (having the same properties as the collapsible pouch 300 and 400 shown in FIGS. 3A-4) and a culinary mix dispenser 700 for delivering (as shown by arrows 625) a culinary mix 735 (of FIG. 7) into the collapsible pouch 600 via the neck 615 coupled to the collapsible pouch 600, in accordance with embodiments.

FIG. 7 is a side perspective view showing a culinary mix dispenser 700, in accordance with embodiments. In one embodiment, a culinary mix dispenser 700 includes: a collapsible body 710 configured for holding the culinary mix 735; a delivery system 705 coupled to the collapsible body 710; and a removable cap 715 configured for sealing the delivery system 705. The delivering system 705 includes a dispensing means 725 configured for dispensing the culinary mix 735 into the collapsible pouch 600 (of FIG. 6). The dispensing means 725, is any means that couples with the collapsible body 710 and is capable of dispensing the culinary mix 735 into the collapsible pouch 600. For example, the culinary mix dispenser 700 may have a funnel-shaped end that operates as the dispensing means 725. The funnel-shaped end may be long and skinny to accommodate placing the funnel-shaped end into the neck 615 of the collapsible pouch 600 in order to dispense the culinary mix 735. Of note, the cap 715 may be of any structure and design that is able to removably seal the dispensing means 725.

In one embodiment, the delivery system 705 further includes a receiving means 730 configured for receiving at least one enhancement (as described herein). In one embodiment, the receiving means 730 is a set of threads atop the collapsible body 710, upon which the dispensing means 725 is threaded, thereby coupling the dispensing means 725 with the collapsible body 710. The dispensing means 725 may be unscrewed from the receiving means 730. Once unscrewed, the dispensing means 725 may be removed, leaving an opening into the collapsible body 710. At least one enhancement may be added to the culinary mix 735 stored within the collapsible body 710. Once added, the dispensing means 725 may be screwed back onto the collapsible body 710 via threading the set of threads of the dispensing means 725 to the set of threads on the receiving means 730. After the dispensing means 725 is coupled to the receiving means 730, the collapsible body 710 may be squeezed repeatedly such that the enhancement(s) added to the culinary mix 735 may be integrated therein (by a modified churning action caused by repeated squeezing of the collapsible body 710). After the enhancement(s) are integrated within the culinary mix 735, the tip end of the dispensing means 725 may be placed into the neck 615 of the collapsible pouch 600 such that the culinary mix 735 may be squeezed into the collapsible pouch 600 (wherein the dispensing means 725 acts as a funnel for guiding the culinary mix 735 into the collapsible pouch 600).

In various embodiments, the culinary mixes are produced and presented in individual packets. For example, but not limited to such example, the following culinary mix packets may be available for use: spaghetti and meatballs; meatloaf; mashed potatoes and gravy; clam chowder; apple pie; spaghetti, meatballs and caffeine; meatloaf and medicine; mashed potatoes and gravy and vitamins; clam chowder and alcohol; and apple pie, vitamins and medicine. In another embodiment, the system further includes an enhancement packet configured for storing at least one enhancement. For example, but not limited to such example, the following enhancement packets may be available to a user: caffeine; vitamin pack; vitamin and crushed Tylenol; alcohol; caffeine and medicine; and a sugar boost.

### Example Method for Manufacturing a System for Dispensing a Nutritive Source

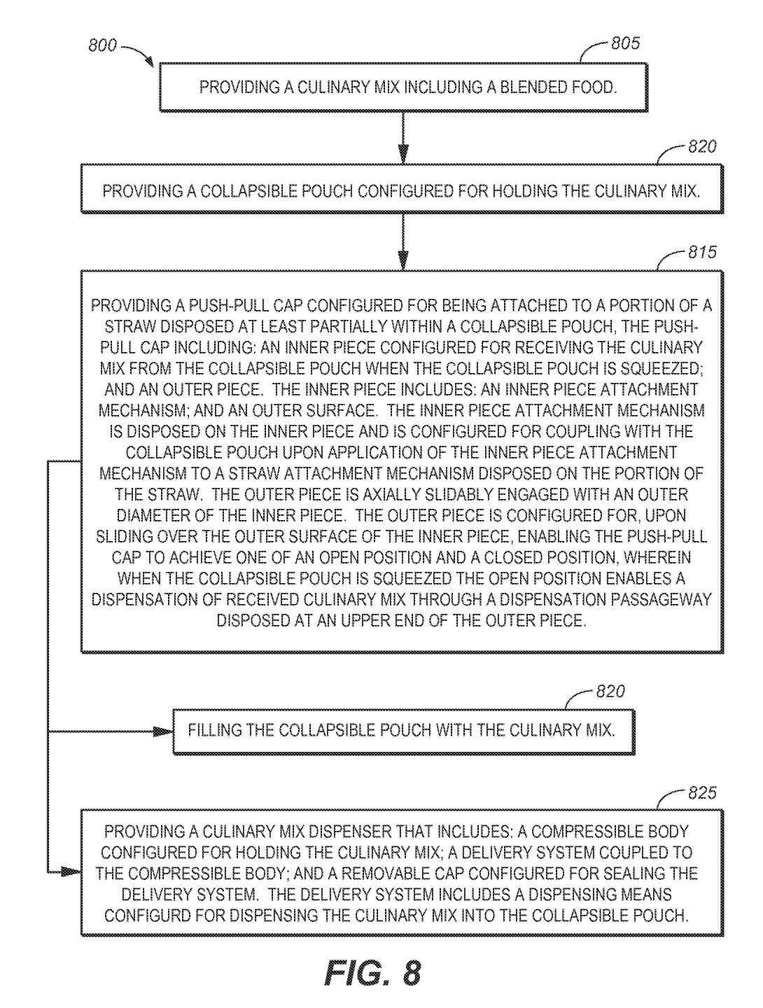

FIG. 8 illustrates an example method 800 for manufacturing a system for dispensing a nutritive source, in accordance with embodiments. It should be appreciated that the steps discussed with reference to the method 800 may be performed in an order different from that which appears in FIG. 8. For example, and not limited to such example, step 810 may be performed before step 805. With reference to FIG. 8, the method 800 for manufacturing a system for dispensing a nutritive source, in one embodiment, includes at step 805, providing a culinary mix that includes the blended food discussed herein.

In one embodiment, the method 800 further comprises at step 810, providing, as described herein, the collapsible pouch discussed herein (e.g., collapsible pouch 300, 400 and 600) configured for holding the culinary mix.

In one embodiment, the method 800 further comprises at step 815, providing, as described herein, the push-pull cap configured for being attached to a portion of a straw disposed at least partially within the collapsible pouch.

In one embodiment, the method 800 further includes at step 820, filling, as described herein, the collapsible pouch with the culinary mix. It should be appreciated that the collapsible pouch may be filled during the manufacture or post-manufacture of the system for dispensing a nutritive source.

In one embodiment, the method 800 further includes at step 825, providing, as described herein, a culinary mix dispenser that includes: a collapsible body configured for holding the culinary mix; a delivery system coupled to the collapsible body; and a removable cap configured for sealing the delivery system. The delivery system includes a dispensing means configured for dispensing the culinary mix into the collapsible pouch. In one embodiment, the delivery system further includes a receiving means configured for receiving at least one enhancement.

All statements herein reciting principles, aspects, and embodiments of the technology as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present technology, therefore, is not intended to be limited to the embodiments shown and described herein. Rather, the scope and spirit of present technology is embodied by the appended claims.

What we claim is:

1. A system for dispensing a nutritive source, said system comprising:
a culinary mix comprising:
a blended food;
a collapsible pouch configured for holding said culinary mix; and
a push-pull cap configured for being coupled with said collapsible pouch, and when said collapsible pouch is squeezed, configured for receiving said culinary mix from said collapsible pouch and for dispensing received culinary mix.

2. The system of claim 1, wherein said blended food comprises:
a thick liquid suspension of food that is finely ground.

3. The system of claim 2, wherein said blended food further comprises:
at least one edible piece of food being of a different state from and a larger state than a state of said thick liquid suspension of food that is said finely ground.

4. The system of claim 1, wherein said push-pull cap is further configured for being removably coupled with said collapsible pouch.

5. The system of claim 1, wherein said push-pull cap is breakably sealed onto a portion of a straw that is disposed at least partially within said collapsible pouch.

6. The system of claim 1, wherein said culinary mix further comprises:
at least one enhancement.

7. The system of claim 6, wherein said at least one enhancement comprises any of the following enhancements:
a set of vitamins; a set of herbs; medicine; electrolytes; and caffeine.

8. The system of claim 6, wherein said at least one enhancement is ground up.

9. The system of claim 1, wherein said culinary mix comprises:
a combination of at least two different food items.

10. The system of claim 1, wherein said system further comprises:
at least one enhancement packet configured for storing at least one enhancement.

11. The system of claim 1, wherein said system further comprises:
a culinary mix dispenser comprising:
a collapsible body configured for holding said culinary mix;
a delivery system coupled to said collapsible body, said delivery system comprising:
a dispensing means configured for dispensing said culinary mix into said collapsible pouch; and
a removable sealing means configured for sealing said delivery system.

12. The system of claim 11, wherein said delivery system further comprises:
a receiving means configured for receiving at least one enhancement.

13. The system of claim 11, further comprising:
an enhancement packet configured for storing at least one enhancement.

14. A device for dispensing a nutritive source, said device comprising:
a push-pull cap configured for being attached to a portion of a straw disposed at least partially within a collapsible pouch, said push-pull cap comprising:
an inner piece configured for receiving a culinary mix from said collapsible pouch when said collapsible pouch is squeezed, wherein said culinary mix comprises a blended food, said inner piece comprising:
an inner piece attachment mechanism disposed thereon, said inner piece configured for coupling with said collapsible pouch upon application of said inner piece attachment mechanism to a straw attachment mechanism disposed on said portion of said straw; and
an outer surface; and
an outer piece axially slidably engaged with an outer diameter of said inner piece, said outer piece configured for, upon sliding over said outer surface of said inner piece, enabling said push-pull cap to achieve one of an open position and a closed position, wherein when said collapsible pouch is squeezed said open position enables a dispensation of received culinary mix through a dispensation passageway disposed at an upper end of said outer piece.

15. The device of claim 14, wherein said push-pull cap is further configured for being removably attached to said portion of said straw.

16. The device of claim 14, wherein said blended food comprises:
a thick liquid suspension of food that is finely ground.

17. The device of claim 16, wherein said blended food further comprises:
at least one edible piece of food being of a different state from and a larger state than a state of said thick liquid suspension of food that is said finely ground.

18. The device of claim 14, wherein said inner piece attachment mechanism comprises:
a first set of threads disposed on an inner surface of said inner piece, and wherein said straw attachment mechanism comprises a second set of threads disposed on an outer surface of said portion of said straw, wherein said portion of said straw is positioned external to said collapsible pouch.

19. The device of claim 14, wherein said inner piece comprises:
an annular lower part comprising:
a first end;
a second end positioned opposite said first end; and
an annular sidewall coupling said first end and said second end, said annular sidewall comprising said inner piece attachment mechanism; and
an annular upper part coupled to said annular lower part via at least two plunger braces having filter passageways disposed there between such that said received culinary mix is enabled to flow there through when said push-pull cap is in said open position, said annular upper part comprising:
an inner diameter that is smaller than an inner diameter of said annular lower part.

20. The device of claim 14, wherein said culinary mix further comprises:
at least one enhancement.

21. A method for manufacturing a system for dispensing a nutritive source, said method comprising:
providing a culinary mix, wherein said culinary mix comprises:
a blended food;
providing a collapsible pouch configured for holding said culinary mix; and
a push-pull cap configured for being attached to a portion of a straw disposed at least partially within a collapsible pouch, said push-pull cap comprising:
an inner piece configured for receiving a culinary mix from said collapsible pouch when said collapsible pouch is squeezed, said inner piece comprising:
an inner piece attachment mechanism disposed thereon, said inner piece configured for coupling with said collapsible pouch upon application of said inner piece attachment mechanism to a straw attachment mechanism disposed on said portion of said straw; and
an outer surface; and
an outer piece axially slidably engaged with an outer diameter of said inner piece, said outer piece configured for, upon sliding over said outer surface of said inner piece, enabling said push-pull cap to achieve one of an open position and a closed position, wherein when said collapsible pouch is squeezed said open position enables a dispensation of received culinary mix through a dispensation passageway disposed at an upper end of said outer piece.

22. The method of claim 21, further comprising:
filling said collapsible pouch with said culinary mix.

23. The method of claim 21, wherein said culinary mix further comprises:
at least one enhancement.

24. The method of claim 21, further comprising:
providing a culinary mix dispenser comprising:
a collapsible body configured for holding said culinary mix;
a delivery system coupled to said collapsible body, said delivery system comprising:
a dispensing means configured for dispensing said culinary mix into said collapsible pouch; and
a removable cap configured for sealing said delivery system.
